(19) United States
(12) Patent Application Publication
(10) Pub. No.: US 2022/0203215 A1
(43) Pub. Date: Jun. 30, 2022

(54) Educational Math Board Game

(71) Applicant: Christine Bradley, Malvern, PA (US)

(72) Inventor: Christine Bradley, Malvern, PA (US)

(21) Appl. No.: 17/561,966

(22) Filed: Dec. 26, 2021

Related U.S. Application Data
(60) Provisional application No. 63/132,839, filed on Dec. 31, 2020.

(51) Int. Cl. A63F 3/04; A63F 9/04

(52) U.S. Cl. CPC A63F 3/0415; A63F 3/0457; G09B 19/02; A63F 2003/046; A63F 9/0415

(57) ABSTRACT

Educational math strategy games and methods of playing the same. The math strategy game may include a game board defining a plurality of spaces, a plurality of dice, and a plurality of distinct sets of game tokens for covering one or more of the plurality of spaces. During game play, a player may roll five dodecahedron dice and select a product of any two dice rolled. A token is placed onto the game board over one of the plurality of spaces matching the product selected. Game play continues until one player or team covers a horizontal, vertical, or diagonal series of adjacent spaces.

### FIELD OF THE INVENTION

The present application relates generally to games, and more particularly, to fun and educational math board games.

### BACKGROUND OF THE INVENTION

Fundamental mathematical operations, namely, addition, subtraction, multiplication and division, are taught to children during their early years of elementary education. Nonetheless, arithmetic and mathematical skills may be difficult for some children to master. In many instances, children are taught to memorize concepts without really understanding what it is that they are learning. For example, children may be encouraged to memorize multiplication tables as a way to understand multiplication. In some cases, however, children struggle with learning these math facts, which may lead to frustration, poor academic performance, lack of confidence, or the like.

There are various types of games, which may help a student to learn or practice math skills. Unfortunately, many games are targeted to children of a limited age range, may be boring or repetitive to play, or may involve little or no strategy. Therefore, there is a need for an entertaining mathematical board game which enables players to learn and/or reinforce math facts with strategic game play.

### SUMMARY OF THE INVENTION

To meet this and other needs, educational math board games are provided. The game may be played to allow children to learn, practice, and/or reinforce math skills, such as multiplication, in a manner that retains their attention, challenges them, and is enjoyable to play. Due to the strategic nature of the board layout, the game may be enjoyable for beginners and master mathematicians alike. The game is designed to engage kids and adults too, which may provide a fun family game night together. The game may be played competitively, cooperatively, based on scoring, speed, or as a single player.

According to one embodiment, the game includes a game board bearing indicia defining a plurality of spaces, a plurality of dice (e.g., dodecahedron dice), and a plurality of distinct sets of game tokens for covering one or more of the plurality of spaces on the game board. The plurality of spaces on the game board are arranged as a grid with a plurality of rows and a plurality of columns. The plurality of spaces each define a numerical value, which are strategically positioned within the plurality of spaces to influence the strategy of game play. There are at least six categories based on the probability of rolling a given numerical value. A higher category correlates to a higher probability of rolling the given numerical value and vice versa. For example, in the case of multiplication, the numerical value assigned to each space may be based on the probability of the product of any two numbers (e.g., appearing on any two dice in a roll).

The game may include one or more of the following features. The dice may include a plurality of dodecahedron dice, for example, five dodecahedron dice. The numerical values and given numerical values may each be a product of two or more numbers, for example, ranging from one to twelve. The categories and probability of rolling a given numerical value (e.g., product) may linearly track with a one-to-one correspondence. The six categories may include a first category having a frequency of being rolled once, a second category having a frequency of being rolled twice, a third category having a frequency of being rolled three times, a fourth category having a frequency of being rolled four times, a fifth category having a frequency of being rolled five times, and a sixth category having a frequency of being rolled six times. The categories may be distinguished from one another, for example, with each category indicated as a different colored space (e.g., six different colors on the board). The plurality of spaces may be circular in shape and each filled in with the respective category colors, for example.

According to one embodiment, a multiplication board game may include a game board bearing indicia defining a plurality of spaces, a plurality of dodecahedron dice, and a plurality of distinct sets of game tokens for covering one or more of the plurality of spaces. The plurality of spaces may be arranged as a grid with a plurality of rows and a plurality of columns. The plurality of spaces may each define a product of two numbers ranging from one to twelve, which are strategically positioned within the plurality of spaces to influence the strategy of game play. There may be six separate categories based on the probability of rolling a given product. A higher category may correlate to a higher probability of rolling the given product and vice versa.

The six categories of the products may include a first category having a frequency of being rolled once, a second category having a frequency of being rolled twice, a third category having a frequency of being rolled three times, a fourth category having a frequency of being rolled four times, a fifth category having a frequency of being rolled five times, and a sixth category having a frequency of being rolled six times. Although the frequencies are given, it will be appreciated that during game play it is possible for a player to roll a given product more or less than the predicted frequency of the given categories.

The six categories of the products may be located at strategic locations around the game board. For example, the fifth category may include a product positioned in a center-most space of the game board. The third category may include four products positioned at least one space away from the center-most space of the game board (e.g., encircling the center-most space). The sixth category may include four products positioned at spaces at the four outer-most corners of the game board. The fourth category products may be located in each row and column of the game board. The first category may include eight products located around the game board. The second category may include a plurality of products filling in the spaces on the remainder of the board. For example, at least four second category products may be located in each row and column of the game board. The categories may be distinguished from one another, for example, with different colored spaces (e.g., orange, purple, blue, yellow, red, and green filled circular spaces). It will be appreciated that the spaces and categories may be distinguished from one another in any suitable manner.

According to yet another embodiment, a method for playing the game may include: (1) rolling a plurality of twelve-sided dice (e.g., five twelve-sided dice); (2) calculating and selecting a product of any two or more dice rolled (e.g., two of the five rolled); (3) placing a game token onto the game board to cover one of the plurality of spaces matching the product selected from any two dice rolled; and (4) continuing play in the above manner, steps (1) through (3), in a sequential fashion among a group of players until one of the players completes a horizontal, vertical, or diagonal series of a predetermined number of adjacent spaces. The horizontal, vertical, or diagonal series of the predetermined number of adjacent spaces may include one player covering four adjacent spaces with game tokens of the same type. The game may include one player against another player or a team of players against another team of players.

Other systems, methods, features, and advantages will be apparent to one with skill in the art upon examination of the following figures and detailed description. It is intended that all such additional systems, methods, features, and advantages be included within this description, be within the scope of the invention, and be protected by the claims.

### BRIEF DESCRIPTION OF THE DRAWINGS

A more complete understanding of the present invention, and the attendant advantages and features thereof, will be more readily understood by reference to the following detailed description when considered in conjunction with the accompanying drawings, wherein:

FIG. 1 shows an educational strategy game including a game board, a plurality of dice, and two distinct sets of tokens according to one embodiment, and

FIG. 2 shows a game board including a plurality of spaces arranged in a grid pattern of column and rows according to one embodiment.

### DETAILED DESCRIPTION OF THE INVENTION

Embodiments of the disclosure are generally directed to board games, systems, and methods thereof. Specifically, embodiments are directed to educational math board games. The game may be played to allow children to learn, practice, and/or reinforce math skills, such as multiplication, in a manner that retains their attention, challenges them, and is enjoyable to play. Due to the strategic nature of the board layout, the game may be enjoyable for beginners and master mathematicians alike. The game is designed to engage kids and adults too, which may provide a fun family game night together.

Additional aspects, advantages and/or other features of example embodiments will become apparent in view of the following detailed description. It should be apparent to those skilled in the art that the described embodiments provided herein are merely exemplary and illustrative and not limiting. Numerous embodiments of modifications thereof are contemplated as falling within the scope of this disclosure and equivalents thereto.

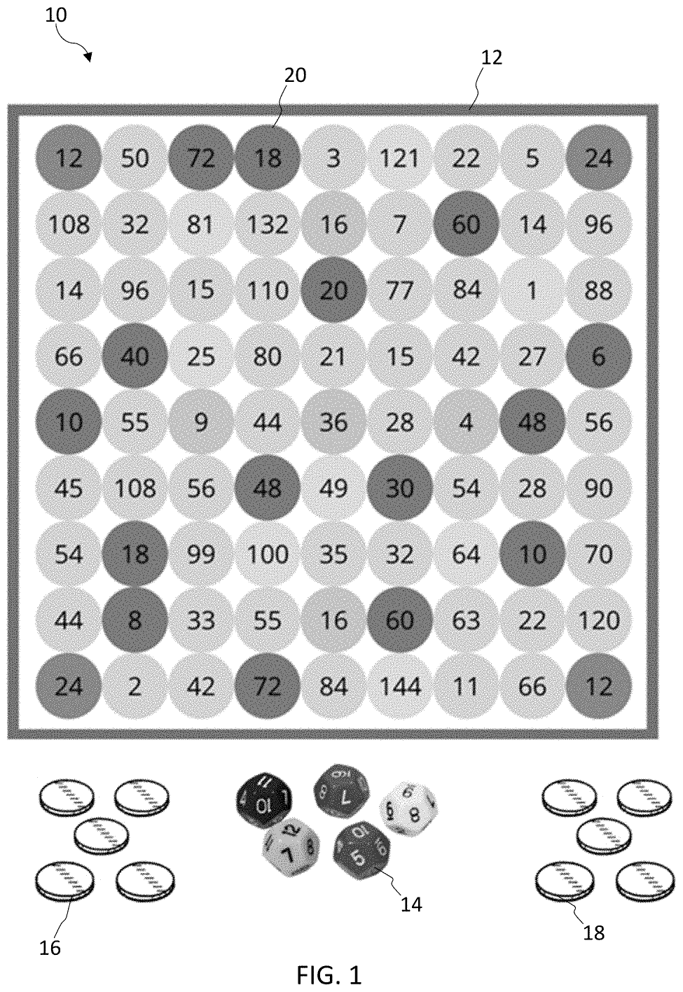

Referring now to FIG. 1, the educational game 10 includes a game board 12, a plurality of dice 14, a first plurality of tokens 16 of a first type, such as a first color, and a second plurality of tokens 18 of a second type, such as a second color different from the first color. The game board 12 may include a planar board made from binding board, chipboard, etc. in a single piece or multi-piece construction. For example, the game board 12 may include a single flat board or a foldable board, which is foldable once (e.g., in half), twice (e.g., in quarters), etc. in a well-known manner for game boards. The outer dimensions of the game board 12 may be generally square, rectangular, or of other suitable shape.

The educational game 10 may include a plurality of dice 14. For example, the dice 14 may include one or more six-sided dice, ten-sided dice, twelve-sided, twenty-sided dice, or any other suitable denomination. The dice 14 may also be provided as a combination of different types of dice (e.g., six-sided dice and twelve-sided dice). In one embodiment, the dice 14 may include one or more dodecahedron (twelve-sided) dice 14. For example, the game 10 may include at least two dodecahedron dice 14, at least three dodecahedron dice 14, at least four dodecahedron dice 14, at least five dodecahedron dice 14, or more. A dodecahedron is a three-dimensional shape having twelve plane faces. One dodecahedron die 14 includes twelve equal pentagonal faces, with values identified one through twelve on each face of the die 14. The values on the dice 14 may be shown as numbers, numerals, dots, or otherwise configured. The geometry of the dice 14 provides an equal chance of landing on any face indicating the value rolled (e.g., one through twelve for the dodecahedron dice 14).

The game 10 may include a plurality of dodecahedron dice 14. For example, during game play, a player may roll two, three, four, five, or more dodecahedron dice 14 on their turn. In one exemplary embodiment, each player rolls five dodecahedron dice 14 on their respective turn. By rolling five dodecahedron dice 14, ten potential outcomes or products may be achieved by multiplying any two of the rolled dice 14. For a beginning player, the player may choose to roll only two dodecahedron dice 14 to simplify the game. For only two dice, the outcome for the two dice always provides a single result, a single product. Thus, a lower number of dice 14 results in a lower number of potential outcomes or products and a higher number of dice 14 results in a higher number of potential outcomes or products. Rolling five dice 14 provides the optimal likelihood of potential outcomes (namely, ten potential results). With less dice, there are fewer outcomes, and in that case, there are fewer options on the board 12 for placing a token 16, 18. In other words, duplicates may be easily rolled, thereby resulting in skipped turn(s) where the game play does not progress. With more dice, there are more outcomes, but rolling more than five dice and/or calculating all of the potential outcomes (e.g., products) may become burdensome for a child.

Although dice are exemplified herein, it will be appreciated that the dice could be replaced with numbered cards, a spinner, or another mechanism for randomly generating numbers. For example, in lieu of dodecahedron dice, playing cards of values one through twelve, in multiple sets, could be used. As an example, two cards may be selected, for example, from the player's hand, to obtain a product of the two cards. Although playing cards or other systems may be substituted for the dice, it is also appreciated that numbered playing cards may have drawbacks. For example, multiple playing cards may be difficult for children to hold and manipulate. Most likely with playing cards, only two cards would be selected to achieve a product, thereby eliminating the statistical significance of rolling five dice. In addition, once cards are played, they are presumably withdrawn from play (perhaps until reshuffled), which changes/reduces the potential likelihood of obtaining certain products. With dice, on the other hand, the probability of rolling a given outcome always remains the same. Finally, the dice may have an additional benefit of providing a tangible sensory element, which enhances the fun for children during game play.

The game 10 may include tokens 16, 18. In one embodiment, the game 10 may include at least two sets of tokens 16, 18 of different types. For example, a first player may possess a first plurality of tokens 16 of a first type, such as a first color (e.g., red), and the second player may possess a second plurality of tokens 18 of a second type, such as a second color (e.g., blue). It is contemplated that the game 10 may include additional sets of tokens (e.g., a third set tokens or a fourth set of tokens) for independent play among three, four, or more players. The game 10 may include enough tokens 16, 18 to cover all of the spaces 20 on the board 12. For example, the game 10 may include at least thirty, at least forty, at least fifty, or at least sixty tokens 16, 18 of each type. By way of example, the game 10 may include a first set of fifty red tokens and a second set of fifty blue tokens.

The tokens 16, 18 may include chips, coins, counters, pawns, or other suitable game pieces. The tokens 16, 18 may be of any suitable size, shape, color, or other features such that at least two separate sets of tokens 16, 18 are easily distinguished from one another. For example, the tokens 16, 18 may be generally circular game tokens of two distinct colors, but it will be appreciated that other suitable shapes and colors may be selected. In one embodiment, the tokens 16, 18 are at least partially transparent such that the spaces and/or numbers on the game board 12 are still visible to the players even after the tokens 16, 18 are placed on the board 12. In this way, the space values (open or covered) are easily visible players for improved game strategy.

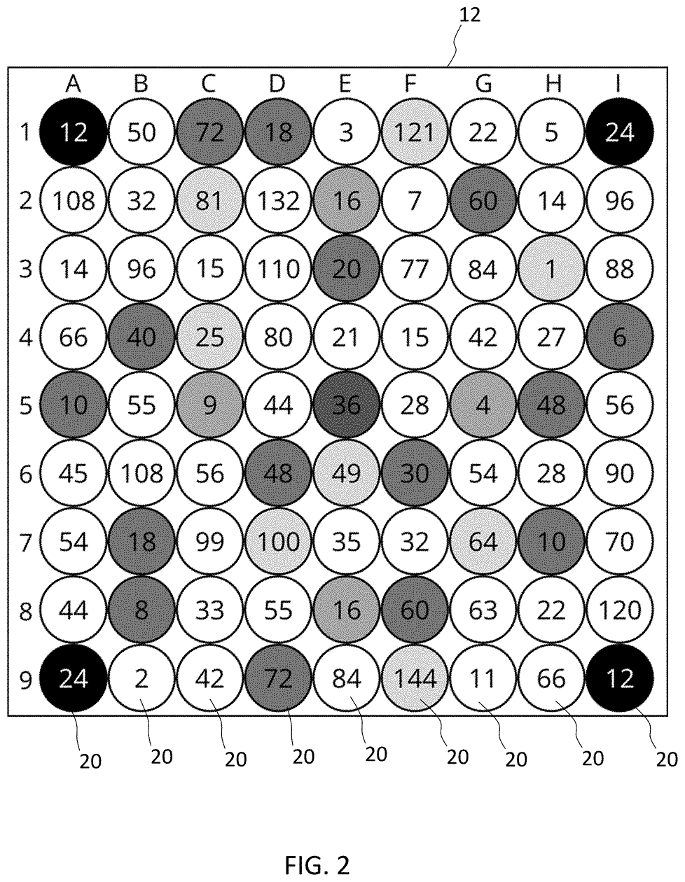

With further emphasis on FIG. 2, the game board 12 may define a plurality of spaces 20 arranged in a grid pattern of rows and columns. The number of spaces 20 in each row and column may be equal. In one embodiment, the grid pattern includes forty-nine spaces 20, sixty-four spaces 20, eighty-one spaces 20, one hundred spaces 20, one hundred and twenty-one spaces 20, or the like. In the embodiment shown, the game board 12 includes eighty-one spaces 20 aligned in nine rows and nine columns. It will be appreciated, however, that the number of spaces 20 may be increased or decreased to influence the game play.

In order to further describe the layout of the board 12, the rows are labeled 1-9 and the columns are labeled A-I in FIG. 2. In this way, one space 20 may be identified by a column letter and row number (e.g., A1 is the space in the upper left-most corner of the board 12). It will be appreciated that the column labels A-I and row labels 1-9 need not be present on the game board 12. Each space 20 may be bounded by a geometric shape, such as a circle, square, rectangle, etc. For example, each space 20 may be identified as a circle. In an exemplary embodiment, each space 20 may be identified as a filled circle of a given color. Each space 20 may identify a numerical value. In the case of multiplication, each space 20 provides a product of two numbers up to twelve times twelve.

The numerical values are strategically positioned within the spaces 20 of the board 12. The numerical values are positioned at given locations within the spaces 20 on the board 12 in order to influence the strategy of placing tokens 16, 18 during game play. For multiplication, when multiplying two numbers rolled from one to twelve, there are six categories based on the frequency, probability, or likelihood of rolling a given product. The higher the category, the easier or more common to roll a given product. In other words, the higher the category, the higher the frequency, probability, or likelihood of rolling that product. Conversely, the lower the category, the harder or less likely to roll a given product. Thus, the lower the category, the lower the frequency, probability, or likelihood of rolling that product. The category and frequency may linearly track with a one-to-one correspondence.

The first category may have a frequency or probability of being rolled once. In other words, the products in the first category are the least likely to be rolled during game play. The product may only statistically be rolled once for two dice 14. By way of example, to obtain a product of twenty-five, two fives must be rolled, and no other combination of dice results, other than two fives, will result in a product of twenty-five. Accordingly, the first category products have a frequency or probability of one.

The second category may have a frequency or probability of two. In other words, the products in the second category are not likely to be rolled during game play. The product may only statistically be rolled two times for two dice 14. By way of example, to obtain a product of fourteen, one die must show seven and the other two (or vice versa). Thus, there are only two dice combinations to obtain this value (namely, a roll of one and seven and a roll of seven and one).

The third category may have a frequency or probability of three. The product may statistically only come up three times for two rolled dice 14. For example, to obtain a product of nine, one die must show one and the other nine (or vice versa) or both dice must show three. Thus, there are only three ways to obtain a given product from two dice 14.

The fourth category has a frequency or probability of four. The product may statistically come up four times for two rolled dice 14. For example, to obtain a product of eight, one die must show one and the other die eight (or vice versa), or one die must show two and the other die four (or vice versa). Accordingly, there are four ways to obtain the given product from two rolled dice 14.

The fifth category has a frequency or probability of five. The product may statistically come up five times for two rolled dice 14. For example, to obtain a product of thirty-six, one die must show three and the other die twelve (or vice versa), one die must show four and the other die nine (or vice versa), or both must dice must show six. Thus, there are five different ways to achieve the product from two dice 14. The products in the fifth category are the more likely to be rolled during game play.

The sixth category has a frequency of probability of six. The product may statistically come up six times for two rolled dice. For example, to obtain a product of twelve, one die must show one and the other die twelve (or vice versa), one die must show two and the other die six (or vice versa), or one die must show three and the other four (or vice versa). Thus, there are six ways to obtain the product from two dice 14. The products in the sixth category are the most likely to be rolled during game play.

Although the statistical likelihoods are given, it will be appreciated that during game play it is possible for a player to roll a given product more or less than the statistical probabilities shown. The table below shows the six categories, corresponding frequencies or probabilities, and potential products for each category when rolling two twelve-sided dice.

| Category | Frequency/Probability | Products |
|---|---|---|
| First (e.g., | One (i.e., least likely | 1, 25, 49, 64, 81, 100, 121, |
| yellow) | rolled) | 144 |
| Second | Two | 2, 3, 5, 7, 11, 14, 15, 21, 22, |
| (e.g., | | 27, 28, 32, 33, 35, 42, 44, 45, |
| green) | | 50, 54, 55, 56, 63, 66, 70, 77, |
| | | 80, 84, 88, 90, 96, 99, 108, |
| | | 110, 120, 132 |
| Third | Three | 4, 9, 16 |
| (e.g., blue) | | |
| Fourth | Four | 6, 8, 10, 18, 20, 30, 40, 48, |
| (e.g., red) | | 60, 72 |
| Fifth (e.g., | Five | 36 |
| orange) | | |
| Sixth | Six (i.e., most commonly | 12, 24 |
| (e.g., | rolled) | |
| purple) | | |

Each of the first through sixth product categories may be distinguished from one another on the board 12. For example, each category may be provided with a different color, pattern, shape, design, or the like. In one embodiment, the first category is shown as yellow filled circle(s), the second category is shown as green filled circle(s), the third category is shown as blue filled circle(s), the fourth category is shown as red filled circle(s), the fifth category is shown as orange filled circle(s), and the sixth category is shown as purple filled circle(s). It will be appreciated that the colors or other attributes of the numerical values and/or spaces 20 may be changed or modified in any way to distinguish the categories from one another on the board 12.

Each of the categories may be positioned on the board 12 to influence the strategy of game play. For example, the fifth category product may be positioned in the center of the board 12. The fifth category product may be positioned at the center-most location (e.g., E5 shown in FIG. 2). By way of example, the product thirty-six may be centrally located in an orange filled circular space 20. Thus, one of the easier products to roll based on probability may be located at the center of the board 12.

The sixth category products, or most commonly rolled products, may be positioned in the four corners of the board 12. For example, the sixth category products may be positioned at corner locations A1, A9, I1, and I9 and positioned in purple filled circular spaces 20. The product twelve may be positioned at locations A1 and I9 and the product twenty four may be positioned at locations A9 and I1 or vice versa. Thus, the easiest products to roll based on probability may be located in the spaces 20 at the four corners of the board 12.

The third category products may be strategically positioned around the board 12. In one embodiment, the third category products may flank the center fifth category product, for example, in blue filled circular spaces 20. The third category products may be located at least one space 20 away, or at least two spaces 20 away from the center-most space 20. Two of the third category products may be positioned in middle column E and two of the third category products may be positioned in middle row 5. For example, four third category products may be located at positions C5, E2, E8, and G5.

The fourth category products may be strategically positioned around the board 12. In one embodiment, at least one fourth category product is located in each row and column of the game board 12. In some cases, one, two, or three fourth category products are located in a given row or column, for example, in red filled circular spaces 20. For example, at least ten fourth category products may be positioned around the board 12. In the embodiment shown in FIG. 2, fifteen fourth category products may be located at positions A5, B4, B7, B8, C1, D1, D6, D9, E3, F6, F8, G2, H5, H7, and I4.

The first category products may be strategically located around the board 12. In one embodiment, some rows and/or columns may contain at least one first category product, for example, in yellow filled circular spaces 20. For example, at least five first category products may be positioned around the board 12. In the embodiment shown in FIG. 2, eight first category products may be located at positions C2, C4, D7, E6, F1, F9, G7, and H3. Thus, the most difficult products to roll based on probability may be located in the given spaces 20 around the board 12.

The second category products may fill in the remainder of the board. In one embodiment, at least two second category products, at least three second category products, or at least four second category products are located in each row and column of the game board 12. In the embodiment shown in FIG. 2, at least four second category products are located in each row and column of the game board 12 in green filled circular spaces 20. The bulk of the board 12 may be filled with second category products. For example, at least thirty spaces, at least forty spaces, or at least forty-eight spaces may be second category products. Thus, the more difficult products to roll based on probability may fill in the majority of the spaces 20 on the board 12.

One or more of the spaces 20 may be open, bonus, or free spaces. If present, the free spaces may be used to complete a series of tokens 16, 18. For example, the four corners of the board 12, the center of the board 12, and/or other suitable spaces 20 may define one or more free spaces. Any player may use the free space(s) as though their token 16, 18 is present on the given free space. If free spaces are present, it will be appreciated that one or more of the categories may be re-distributed and/or the number of spaces 20 increased to achieve the desired strategical outcomes.

The spaces 20 may be aligned in a grid such that when tokens 16, 18 are placed on the spaces 20, the tokens 16, 18 may be aligned in straight lines: vertically, horizontally, or diagonally. The first player or team to complete a connected series of tokens 16, 18 (e.g., four) of the same type (e.g., color) in a straight line (e.g., up/down, across, or diagonally) wins the game. The winning connected series of tokens 16, 18 may include three, four, five, or more tokens 16, 18 of a single type.

During competitive game play, two or more players may compete to complete the series of tokens 16, 18. For example, two players may work against one another for the first to complete four tokens in a row (vertically, horizontally, or diagonally) in adjacent or touching spaces 20. Four players may compete in two teams for the first team to complete four tokens in a row. Single player play may include rolling two dice 14 and filling in as many spaces as possible under a timed duration, for example.

During set-up, the game board 12 is placed on a flat surface with an area to roll the dice 14. Each player (or team) obtains one set of tokens 16, 18. In turn, each player rolls five twelve-sided dice 14. Optionally, beginners may utilize only two dice to simplify game play. After rolling five dice 14, the player chooses to multiply any two values of the five rolled dice 14 and places one token 16, 18 on the board 12 covering the product selected. If no tokens 16, 18 may be placed, the player's turn may be skipped.

The spaces 20 on the board 12 represent the statistical frequency of the relative products and may influence the strategy of game play. For two player games, each player alternates turns placing tokens 16, 18 based on the product of any two numbers rolled out of the five dice rolled. For four player competitive games, each team alternates turns. The teammates may or may not discuss the strategy for token placement during game play. If instructed not to discuss game strategy, each player in the team must independently assess the significance of token placement without assistance. Game play may continue in a clockwise direction until one of the players completes the series of tokens (e.g., four) of the same type (e.g., color) in a row (vertically, horizontally, or diagonally), thereby winning the game.

According one embodiment, a method for playing the game may include: (1) rolling a plurality of dice (e.g., five twelve-sided dice); (2) calculating and selecting a product of any two dice rolled (e.g., any two of the five rolled); (3) placing a game token onto the game board to cover one of the plurality of spaces matching the product selected from any two dice rolled; and (4) continuing play in the above manner, steps (1) through (3), in a sequential fashion among a group of players until one of the players completes a horizontal, vertical, or diagonal series of a predetermined number of adjacent spaces (e.g., four adjacent spaces).

During competitive scoring game play, two to four players may compete to a predetermined winning score, e.g., 500 points to win. A score sheet is provided on a piece of paper with a column for each player or team. The player or team name may be placed at the top of each column. In turn, each player rolls five twelve-sided dice. Optionally, beginners may utilize only two dice. The player multiplies any two values on the five dice and places a token on the board covering that product. The product equals the number of points. The scoring method encourages players to select higher values and harder multiplication facts. The number of points or product is written on the score sheet for that player or team. If no tokens may be placed, the player's turn is skipped. The points in the column for each player or team are added up on each turn. The first player or team to reach 500 points, for example, wins the game.

During competitive speed play, the first player to complete a connected series of four tokens of the same color in a straight line (up, down, across, or diagonally) wins. Each player gets two twelve-sided dice. As quickly as possible, players roll the dice, multiply the product, and place a token covering that product. Players may re-roll and place chips as fast as they can. The fastest and first player to cover four tokens in a row (up, down, across, or diagonally) wins the speed game.

During cooperative play, all players work together to complete a connected series of tokens in a straight line, e.g., nine tokens up/down or across. In turn, each player rolls five twelve-sided dice. Optionally, beginners may utilize only two dice. The player multiplies any two values on the five dice and places a token on the board covering that product. If no tokens may be placed, the player's turn is skipped. The colors on the board represent the statistical frequency of the relative products and may influence the strategy of play. Players work together cooperatively to complete an entire line of tokens, for example, nine tokens up/down or across the board to win the game.

During a timed game for a single player, play against a previous record for yourself or another. Set a timer for two minutes (or other suitable duration) and roll two dice. Cover each product rolled with a token and keep track of the number of tokens placed. Keep playing for more practice and to try to beat previously rounds.

During scored play for a single player, the player scores until a predetermined winning score, e.g., 500 points. The player may roll up to five twelve-sided dice. The player multiplies any two values on the dice and place a token on the board covering that product. The product equals the number of points. The points are scored, for example, on a sheet of paper, and the points are added up on each turn. The scoring method encourages the player to select higher values and harder multiplication facts. Play continues until the player reaches the winning score, e.g., 500 points, to win the game.

Thematic gameplay and story elements may also be included to appeal to a wider audience of learners. For example, the board may contain graphical elements to provide one or more themes, such as ocean, underground, forest, outer space, fantasy, or other suitable themes. The board game may include additional cards, pieces, and/or rulesets with one or more themes including, but not limited to, dinosaurs, pirates, explorers, unicorns, or other elements to enhance the appeal of the game. The thematic elements may alter the shape or placement of the spaces in such a way as to provide additional strategical or challenging mathematical concepts.

The educational game may be played to allow children to learn, practice, and/or reinforce math skills, such as multiplication facts, in a way that is fun, retains their attention, and challenges them. Due to the strategic nature of the board layout, the game may be enjoyable for beginners and master mathematicians alike. The game is designed to engage kids and adults too, which may provide a fun family game night together.

Although the invention has been described in detail and with reference to specific embodiments, it will be apparent to one skilled in the art that various changes and modifications can be made without departing from the spirit and scope of the invention. Thus, it is intended that the invention covers the modifications and variations of this invention provided they come within the scope of the appended claims and their equivalents. It is expressly intended, for example, that all components of the various devices disclosed above may be combined or modified in any suitable configuration.

What is claimed is:

1. A board game comprising:
a game board bearing indicia defining a plurality of spaces, wherein the plurality of spaces are arranged as a grid with a plurality of rows and a plurality of columns, wherein the plurality of spaces each define a numerical value, wherein the numerical values are strategically positioned within the plurality of spaces to influence the strategy of game play, wherein there are at least six categories based on the probability of rolling a given numerical value, and wherein a higher category correlates to a higher probability of rolling the given numerical value;
a plurality of dice; and
a plurality of distinct sets of game tokens for covering one or more of the plurality of spaces.

2. The board game of claim 1, wherein the plurality of dice includes five dodecahedron dice.

3. The board game of claim 1, wherein the numerical value is a product of two numbers ranging from one to twelve.

4. The board game of claim 1, wherein the categories and probability of rolling the given numerical value linearly track with a one-to-one correspondence.

5. The board game of claim 4, wherein the at least six categories includes a first category having a frequency of being rolled once, a second category having a frequency of being rolled twice, a third category having a frequency of being rolled three times, a fourth category having a frequency of being rolled four times, a fifth category having a frequency of being rolled five times, and a sixth category having a frequency of being rolled six times.

6. The board game of claim 1, wherein the categories are distinguished from one another, wherein each category is indicated as a different colored space.

7. The board game of claim 1, wherein the plurality of spaces are each circular in shape.

8. A multiplication board game comprising:
a game board bearing indicia defining a plurality of spaces, wherein the plurality of spaces are arranged as a grid with a plurality of rows and a plurality of columns, wherein the plurality of spaces each define a product of two numbers ranging from one to twelve, wherein the products are strategically positioned within the plurality of spaces to influence the strategy of game play, wherein there are six categories based on the probability of rolling a given product, and wherein a higher category correlates to a higher probability of rolling the given product;
a plurality of dodecahedron dice; and
a plurality of distinct sets of game tokens for covering one or more of the plurality of spaces.

9. The board game of claim 8, wherein the plurality of dodecahedron dice includes five dodecahedron dice.

10. The board game of claim 8, wherein the categories and probability of rolling a given product linearly track with a one-to-one correspondence.

11. The board game of claim 10, wherein the six categories includes a first category having a frequency of being rolled once, a second category having a frequency of being rolled twice, a third category having a frequency of being rolled three times, a fourth category having a frequency of being rolled four times, a fifth category having a frequency of being rolled five times, and a sixth category having a frequency of being rolled six times.

12. The board game of claim 11, wherein the fifth category includes the product positioned in a center-most space of the game board.

13. The board game of claim 12, wherein the third category includes four products positioned at least one space away from the center-most space of the game board.

14. The board game of claim 11, wherein the sixth category includes four products positioned at spaces at the four corners of the game board.

15. The board game of claim 11, wherein the fourth category is located in each row and column of the game board.

16. The board game of claim 11, wherein the first category includes eight products located around the game board.

17. The board game of claim 11, wherein the second category includes a plurality of products filling in the spaces on the remainder of the board, wherein at least four products are located in each row and column of the game board.

18. The board game of claim 10, wherein the categories are distinguished from one another, wherein each category is indicated as a different colored space.

19. The board game of claim 8, wherein the plurality of spaces are each circular in shape.

20. A method of playing a mathematical board game, the method comprising:
rolling a plurality of twelve-sided dice;
selecting a product of any two dice rolled;
placing a game token onto a game board defining a plurality of spaces, wherein the plurality of spaces are arranged as a grid with a plurality of rows and a plurality of columns, wherein the plurality of spaces each define a numerical value, wherein the numerical values are strategically positioned within the plurality of spaces to influence the strategy of game play, wherein there are at least six categories based on the probability of rolling a given numerical value, wherein a higher category correlates to a higher probability of rolling the given numerical value, wherein the game token is placed over one of the plurality of spaces matching the product selected from any two dice rolled; and
continuing play in the above manner in a sequential fashion among a group of players until one of the players completes a horizontal, vertical, or diagonal series of a predetermined number of adjacent spaces.
